(19) United States
(12) Patent Application Publication
(10) Pub. No.: US 2025/0227528 A1
(43) Pub. Date: Jul. 10, 2025

(54) MEASUREMENT GAP SCALING BASED ON INTER-GAP PROXIMITY IN CONCURRENT GAP PATTERN

(71) Applicant: Telefonaktiebolaget LM Ericsson (publ), Stockholm (SE)

(72) Inventors: Ming LI, Stockholm (SE); Zhixun TANG, Beijing (CN); Muhammad Ali KAZMI, Sundbyberg (SE)

(21) Appl. No.: 18/703,094

(22) PCT Filed: Oct. 21, 2022
(86) PCT No.: PCT/SE2022/050966

§ 371 Date: Apr. 19, 2024

Related U.S. Application Data
(60) Provisional application No. 63/271,066, filed on Oct. 22, 2021.

(51) Int. Cl. H04W 24/10; H04W 64/00

(52) U.S. Cl. CPC H04W 24/10; H04W 64/00

(57) ABSTRACT

A method performed by a radio node includes configuring a plurality of measurement gap patterns for performing measurements by a user equipment during measurement gaps, grouping the plurality of measurement gap patterns into a plurality of measurement gap pattern sets, determining that an overlap exists between two or more measurement gap occasions belonging to different measurement gap pattern sets, and adapting at least one of the measurement gap pattern sets in response to determining that the overlap exists. The radio node may be a radio network node or a user equipment.

### TECHNICAL FIELD

The present disclosure relates generally to communications, and more particularly to communication methods and related devices and nodes supporting wireless communications.

### BACKGROUND

In a wireless communication system, a measurement gap pattern (MGP) is used by a communication device (e.g., a user equipment, or UE) for performing measurements on cells of the non-serving carriers (e.g. inter-frequency carrier, inter-RAT carriers etc.). In NR, gaps are also used for measurements on cells of the serving carrier in some scenarios, such as if the measured signals (e.g., a synchronization signal block, SSB) are outside the bandwidth part (BWP) of the serving cell. The UE is scheduled in the serving cell only within the BWP. During the gap the UE cannot be scheduled for receiving/transmitting signals in the serving cell. A measurement gap pattern is characterized or defined by several parameters: measurement gap length (MGL), measurement gap repetition period (MGRP) and measurement gap time offset with respect to reference time (e.g. slot offset with respect to serving cell's SFN such as SFN=0). An example of MGP is shown in FIG. 1. As an example MGL can be 1.5, 3, 3.5, 4, 5.5 or 6 ms, and MGRP can be 20, 40, 80 or 160 ms. Such type of MGP is configured by the network node and is also called as network controlled or network configurable MGP. Therefore the serving base station is fully aware of the timing of each gap within the MGP.

In NR there are two major categories of MGPs: per-UE measurement gap patterns and per-FR measurement gap patterns. In NR the spectrum is divided into two frequency ranges namely FR1 and FR2. FR1 is currently defined from 410 MHz to 7125 MHz. FR2 range is currently defined from 24250 MHz to 52600 MHz. The FR2 range is also interchangeably called millimeter wave (mmwave) and corresponding bands in FR2 are called mmwave bands. In future more frequency ranges can be specified, such as FR3. An example of FR3 is frequency ranging above 52600 MHz or between 52600 MHz and 71000 MHz or between 7125 MHz and 24250 MHz.

When configured with per-UE MGP, the UE creates gaps on all the serving cells (e.g. PCell, PSCell, SCells etc) regardless of their frequency range. The per-UE MGP can be used by the UE for performing measurements on cells of any carrier frequency belonging to any RAT or frequency range (FR). When configured with per-FR MGP (if UE supports this capability), the UE creates gaps only on the serving cells of the indicated FR whose carriers are to be measured. For example, if the UE is configured with per-FR1 MGP then the UE creates measurement gaps only on serving cells (e.g. PCell, PSCell, SCells etc) of FR1 while no gaps are created on serving cells on carriers of FR2. The per-FR1 gaps can be used for measurement on cells of only FR1 carriers. Similarly, per-FR2 gaps when configured are only created on FR2 serving cells and can be used for measurement on cells of only FR2 carriers. Support for per FR gaps is a UE capability, i.e. certain UE may only support per UE gaps according to their capability.

A MeasGapConfig information element carried in an RRC message for measurement gap configuration provided by network node to UE is shown in Table 1 below.

TABLE 1
MeasGapConfig information element

The IE MeasGapConfig specifies the measurement gap configuration and controls
setup/release of measurement gaps.
MeasGapConfig information element
-- ASN1START
-- TAG-MEASGAPCONFIG-START

| | |
|---|---|
| MeasGapConfig ::= | SEQUENCE { |
| gapFR2 | SetupRelease { GapConfig } |

```
OPTIONAL, -- Need M
  ...,
  [[
```

| | |
|---|---|
| gapFR1 | SetupRelease { GapConfig } |

OPTIONAL, -- Need M

| | |
|---|---|
| gapUE | SetupRelease { GapConfig } |

OPTIONAL -- Need M
]]
}

| | |
|---|---|
| GapConfig ::= | SEQUENCE { |
| gapOffset | INTEGER (0..159), |
| mg1 | ENUMERATED {ms1dot5, ms3, ms3dot5, |

ms4, ms5dot5, ms6},

| | |
|---|---|
| mgrp | ENUMERATED {ms20, ms40, ms80, |

ms160},

| | |
|---|---|
| mgta | ENUMERATED {ms0, ms0dot25, ms0dot5}, |

```
  ...,
  [[
```

| | |
|---|---|
| refServCellIndicator | ENUMERATED {pCell, pSCell, mcg-FR2} |

```
OPTIONAL -- Cond NEDCorNRDC
ServCellIndex
  ]],
  [[
```

| | |
|---|---|
| refFR2ServCellAsyncCA-r16 | ServCellIndex |

OPTIONAL, -- Cond AsyncCA

| | |
|---|---|
| mgl-r16 | ENUMERATED {ms10, ms20} |

OPTIONAL -- Cond PRS
]]
}
-- TAG-MEASGAPCONFIG-STOP
-- ASN1STOP
Meas GapConfig field descriptions
gapFR1
Indicates measurement gap configuration that applies to FR1 only. In (NG)EN-DC, gapFR1 cannot be set up
by NR RRC (i.e. only LTE RRC can configure FR1 measurement gap). In NE-DC, gapFR1 can only be set up
by NR RRC (i.e. LTE RRC cannot configure FR1 gap). In NR-DC, gapFR1 can only be set up in the
measConfig associated with MCG. gapFR1 can not be configured together with gapUE. The applicability of the
FR1 measurement gap is according to Table 9.1.2-2 and Table 9.1.2-3 in TS 38.133 [14].
gapFR2
Indicates measurement gap configuration applies to FR2 only. In (NG)EN-DC or NE-DC, gapFR2 can only be
set up by NR RRC (i.e. LTE RRC cannot configure FR2 gap). In NR-DC, gapFR2 can only be set up in the
measConfig associated with MCG. gapFR2 cannot be configured together with gapUE. The applicability of the
FR2 measurement gap is according to Table 9.1.2-2 and Table 9.1.2-3 in TS 38.133 [14].
gapUE
Indicates measurement gap configuration that applies to all frequencies (FR1 and FR2). In (NG)EN-DC, gapUE
cannot be set up by NR RRC (i.e. only LTE RRC can configure per UE measurement gap). In NE-DC, gapUE
can only be set up by NR RRC (i.e. LTE RRC cannot configure per UE gap). In NR-DC, gapUE can only be set
up in the measConfig associated with MCG. If gapUE is configured, then neither gapFR1 nor gapFR2 can be
configured. The applicability of the per UE measurement gap is according to Table 9.1.2-2 and Table 9.1.2-3 in
TS 38.133 [14] .
gapOffset
Value gapOffset is the gap offset of the gap pattern with MGRP indicated in the field mgrp. The value range is
from 0 to mgrp-1.
mgl
Value mgl is the measurement gap length in ms of the measurement gap. The measurement gap length is
according to in Table 9.1.2-1 in TS 38.133 [14]. Value ms1dot5 corresponds to 1.5 ms, ms3 corresponds to 3
ms and so on. If mgl-r16 is present, UE shall ignore the mgl (without suffix).
mgrp
Value mgrp is measurement gap repetition period in (ms) of the measurement gap. The measurement gap
repetition period is according to Table 9.1.2-1 in TS 38.133 [14].
mgta
Value mgta is the measurement gap timing advance in ms. The applicability of the measurement gap timing
advance is according to clause 9.1.2 of TS 38.133 [14]. Value ms0 corresponds to 0 ms, ms0dot25
corresponds to 0.25 ms and ms0dot5 corresponds to 0.5 ms. For FR2, the network only configures 0 ms and
0.25 ms.
refFR2ServCelllAsyncCA
Indicates the FR2 serving cell identifier whose SFN and subframe is used for FR2 gap calculation for this gap
pattern with asynchronous CA involving FR2 carrier(s).
refServCellIndicator
Indicates the serving cell whose SFN and subframe are used for gap calculation for this gap pattern. Value
pCell corresponds to the PCell, pSCell corresponds to the PSCell, and mcg-FR2 corresponds to a serving cell
on FR2 frequency in MCG.

| Conditional | |
|---|---|
| Presence | Explanation |
| AsyncCA | This field is mandatory present when configuring FR2 gap pattern to UE in: |
| | -(NG)EN-DC or NR SA with asynchronous CA involving FR2 carrier(s); |
| | -NE-DC or NR-DC with asynchronous CA involving FR2 carrier(s), if the field |
| | refServCellindicator is set to mcg-FR2. |
| | In case the gap pattern to UE in NE-DC and NR-DC is already configured and the |
| | serving cell used for the gap calculation corresponds to a serving cell on FR2 frequency |
| | in MCG, then the field is optionally present, need M. Otherwise, it is absent, Need R. |
| NEDCorNRDC | This field is mandatory present when configuring gap pattern to UE in NE-DC or NR-DC. |
| | In case the gap pattern to UE in NE-DC and NR-DC is already configured, then the field |
| | is absent, need M. Otherwise, it is absent. |
| PRS | This field is optionally present, Need R, when configuring gap pattern to UE for |
| | measurements of DL-PRS configured via LPP (TS 37.355 [49]). Otherwise, it is absent. |

### Concurrent Gaps

In NR Rel-17 work is ongoing for introducing concurrent measurement gap patterns (C-MGP), i.e., support of at least two measurement gap patterns that are configured during the same period of time. The C-MGP is also interchangeably called as concurrent gaps or concurrent measurement gaps or parallel gaps or parallel measurement gap pattern etc. C-MGP comprises of multiple measurement gap patterns (e.g. 2 or more MGPs) which can be configured by the network node using the same or different messages (e.g. same or different RRC messages). Each individual MGP in the C-MGP can be periodic (e.g. gap recurs after MGRP) or it can be aperiodic (e.g. one occurrence of the gap). Therefore the C-MGP pattern may comprise any combination of one or more periodic MGPs and one or more aperiodic MGPs or all MGPs belonging to the C-MGP can be periodic or all MGPs belonging to the C-MGP can be aperiodic.

Some exemplary scenarios for concurrent gaps assuming periodic MGPs are shown in FIG. 2.

The scenario in FIG. 2(a) illustrates two fully non-overlapping measurement gap patterns. Although here the measurement gap repetition periods (MGRP) are illustrated as being the same for both measurement gap patterns, this is not a requirement for the scenario to apply; MGRPs can differ between the MGPs (for example, one MGRP may be 40 ms and the other 40 ms or 80 ms), and the scenario is fulfilled as long as measurement gaps in one MGP never overlaps, partially or fully, with a measurement gap in another MGP. In standardization discussions this scenario is referred to as the fully non-overlapping (FNO) scenario.

The scenarios in FIG. 2(b) illustrate two fully overlapping measurement gap patterns. In either case, one MGP is always contained within the other, and the MGRPs for the two MGPs are the same MGRP. In standardization discussions these scenarios are referred to as fully overlapping (FO) scenarios.

The scenario in FIG. 2(c) illustrates two measurement gap patterns that whose gaps consistently partially overlap each other. The MGRPs are the same MGRP. In the standardization discussions this scenario is referred to as the fully-partial overlapped (FPO) scenario.

The scenario in FIG. 2(d) illustrates two measurement gap patterns that at least occasionally fully overlap each other. For this scenario to apply, the MGRPs have to be different, for example, one MGRP 40 ms and the other MGRP 80 ms. In the standard this scenario is referred to as the partially-fully overlapped (PFO) scenario.

The scenario in FIG. 2(e) illustrates two measurement gap patterns whose gaps at least occasionally partially overlap each other. For this scenario to apply, the MGRPs for the two measurement gap patterns have to be different, such as where one MGRP is 40 ms and the other MGRP is 80 ms. In the standardization discussion this scenario is referred to as the partially-partial overlapped (PPO) scenario.

It has been agreed in RAN4 that radio resource management (RRM) requirements are to be defined at least for the FNO scenario.

### Multi-SIM Operation

A multi-USIM (MUSIM) UE has two or more subscriptions for different services (e.g. use one individual subscription and one family circle plan). Each USIM or SIM may be associated with one subscription of a mobile network operator (MNO). Different USIM or SIM in the UE may be associated with or belong to or registered with the same operator or different operators. In one MUSIM scenario the UE may be in RRC idle or inactive with respect to all the registered networks. In this case the UE need to monitor and receive paging from more than one network. In another MUSIM scenario the UE may be in RRC idle or inactive with respect to one of the registered networks while in RRC connected mode to another network. In this case the UE need to monitor and receive paging from one network while receiving/transmitting data in another network. The term multi-USIM may also be called as multi-subscription, multi-SIM or dual SIM or dual-USIM etc.

In multi-USIM operation the UE may be configured with one or more measurement gap patterns for performing measurements on each of the plurality of the network. For example, network A (e.g. by serving cell A) may configure the UE with one or more MGPs for performing measurements on one or more cells of the network B. These MGPs may also be termed as concurrent MGP (C-MGP).

### SUMMARY

Certain aspects of the disclosure and their embodiments may provide solutions to these or other challenges. In particular, certain embodiments provide mechanisms for the UE to adjust measurements in a timely manner. For example, some embodiments provide a way for a UE to perform fewer measurements for mobility and signaling with multi-MG configurations, which may potentially reduce power consumption of UE and signaling overhead.

A method performed by a radio node includes configuring a plurality of measurement gap patterns for performing measurements by a user equipment during measurement gaps, grouping the plurality of measurement gap patterns into a plurality of measurement gap pattern sets, determining that an overlap exists between two or more measurement gap occasions belonging to different measurement gap pattern sets, and adapting at least one of the measurement gap pattern sets in response to determining that the overlap exists.

Some embodiments provide a user equipment including a processor, a transceiver connected to the processor, and a memory connected to the processor. The memory contains computer readable program instructions, that when executed by the processor, cause the user equipment to configure a plurality of measurement gap patterns for performing measurements by the user equipment during measurement gaps, group the plurality of measurement gap patterns into a plurality of measurement gap pattern sets, determine that an overlap exists between two or more measurement gap occasions belonging to different measurement gap pattern sets, and adapt at least one of the measurement gap pattern sets in response to determining that the overlap exists.

Some embodiments provide a computer program product including a non-transitory storage medium including program code to be executed by processing circuitry of a user equipment, whereby execution of the program code causes the user equipment to configure a plurality of measurement gap patterns for performing measurements by the user equipment during measurement gaps, group the plurality of measurement gap patterns into a plurality of measurement gap pattern sets, determine that an overlap exists between two or more measurement gap occasions belonging to different measurement gap pattern sets, and adapt at least one of the measurement gap pattern sets in response to determining that the overlap exists.

Some embodiments provide a network node including a processor, a transceiver connected to the processor, and a memory connected to the processor. The memory contains computer readable program instructions, that when executed by the processor, cause the network node to configure a plurality of measurement gap patterns for performing measurements by a user equipment during measurement gaps, group the plurality of measurement gap patterns into a plurality of measurement gap pattern sets, determine that an overlap exists between two or more measurement gap occasions belonging to different measurement gap pattern sets, and adapt at least one of the measurement gap pattern sets in response to determining that the overlap exists.

Some embodiments provide a computer program product including a non-transitory storage medium including program code to be executed by processing circuitry of a network node, whereby execution of the program code causes the network node to configure a plurality of measurement gap patterns for performing measurements by a user equipment during measurement gaps, group the plurality of measurement gap patterns into a plurality of measurement gap pattern sets, determine that an overlap exists between two or more measurement gap occasions belonging to different measurement gap pattern sets, and adapt at least one of the measurement gap pattern sets in response to determining that the overlap exists.

Some embodiments provide a user equipment configured to configure a plurality of measurement gap patterns for performing measurements by the user equipment during measurement gaps, group the plurality of measurement gap patterns into a plurality of measurement gap pattern sets, determine that an overlap exists between two or more measurement gap occasions belonging to different measurement gap pattern sets, and adapt at least one of the measurement gap pattern sets in response to determining that the overlap exists.

Some embodiments provide a network node configured to configure a plurality of measurement gap patterns for performing measurements by a user equipment during measurement gaps, group the plurality of measurement gap patterns into a plurality of measurement gap pattern sets, determine that an overlap exists between two or more measurement gap occasions belonging to different measurement gap pattern sets, and adapt at least one of the measurement gap pattern sets in response to determining that the overlap exists.

### BRIEF DESCRIPTION OF THE DRAWINGS

FIG. 1 illustrates an example of a measurement gap pattern.

FIG. 2 illustrates various overlapping, partially overlapping and non-overlapping measurement gap patterns.

FIG. 3 illustrates an example of a measurement gap pattern according to some embodiments.

FIG. 4 illustrates an example of a measurement gap pattern according to some embodiments.

FIG. 5 illustrates an example of a measurement gap pattern according to some embodiments.

FIG. 6 shows a measurement gap pattern set including a measurement gap for mobility and a measurement gap set including measurement gaps for MUSIM.

FIG. 7 illustrates a mapping relationship between measurement gaps according to some embodiments.

FIG. 8 illustrates a mapping relationship between measurement gaps according to some embodiments.

FIG. 9 illustrates operations of a method performed by a user equipment according to some embodiments.

FIG. 10 illustrates operations of a method performed by a user equipment according to some embodiments.

FIG. 11 illustrates operations of a method performed by a network node according to some embodiments.

FIG. 12 illustrates operations of a method performed by a network node according to some embodiments.

FIG. 13 is a block diagram of a communication system in accordance with some embodiments.

FIG. 14 is a block diagram of a user equipment in accordance with some embodiments.

FIG. 15 is a block diagram of a network node in accordance with some embodiments.

FIG. 16 is a block diagram of a host computer communicating with a user equipment in accordance with some embodiments.

FIG. 17 is a block diagram of a virtualization environment in accordance with some embodiments.

FIG. 18 is a block diagram of a host computer communicating via a base station with a user equipment over a partially wireless connection in accordance with some embodiments in accordance with some embodiments.

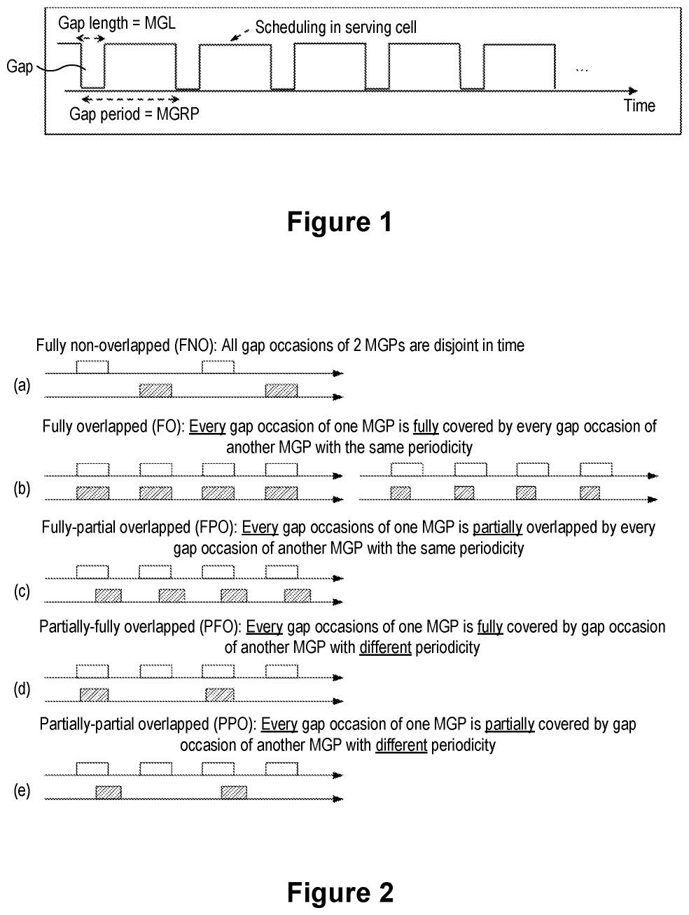

### DESCRIPTION OF EMBODIMENTS

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The term “node” can refer to a network node or a user equipment (UE). Examples of network nodes are NodeB, base station (BS), multi-standard radio (MSR) radio node such as MSR BS, eNodeB, gNodeB, MeNB, SeNB, location measurement unit (LMU), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, transmission reception point (TRP), RRU, RRH, nodes in distributed antenna system (DAS), core network node (e.g. MSC, MME etc), O&M, OSS, SON, positioning node (e.g. E-SMLC), etc.

The non-limiting term “UE” refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, PDA, tablet, mobile terminals, smart phone, laptop embedded equipment (LEE), laptop mounted equipment (LME), USB dongles etc.

The term “radio access technology,” or RAT, may refer to any RAT, is based on type of carriers, such as UTRA, E-UTRA, narrow band internet of things (NB-IoT), WiFi, Bluetooth, next generation RAT, New Radio (NR), 4G, 5G, etc. Any of the equipment denoted by the term node, network node or radio network node may be capable of supporting a single or multiple RATs.

The term “signal” or “radio signal” can be any physical signal or physical channel. Examples of DL physical signals are reference signal (RS) such as PSS, SSS, CSI-RS, DMRS signals in SS/PBCH block (SSB), discovery reference signal (DRS), CRS, PRS etc. RS may be periodic, such as an occasion carrying one or more RSs may occur with certain periodicity, such as 20 ms, 40 ms etc. The RS may also be aperiodic. Each SSB carries NR-PSS, NR-SSS and NR-PBCH in 4 successive symbols. One or multiple SSBs are transmit in one SSB burst which is repeated with certain periodicity, such as 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset wrt reference time (e.g. serving cell's SFN) etc. Therefore, SMTC occasion may also occur with certain periodicity, such as 5 ms, 10 ms, 20 ms, 40 ms, 80 ms and 160 ms. Examples of UL physical signals are reference signal such as SRS, DMRS etc. The term physical channel refers to any channel carrying higher layer information, such as data, control etc. Examples of physical channels are PBCH, NPBCH, PDCCH, PDSCH, sPUCCH, SPDSCH, sPUCCH, sPUSCH, MPDCCH, NPDCCH, NPDSCH, E-PDCCH, PUSCH, PUCCH, NPUSCH etc.

The term “operation” of a signal may comprise transmission of the signal by the UE and/or reception of the signal at the UE.

There currently exist certain challenge(s). For example, when a UE supports multiple measurement gap capabilities, such as concurrent gaps, or MUSIM gaps or other type of MGPs, a network node may configure multiple MGPs to the UE. In that case, some of the MGPs' measurement occasions or gap occasions (i.e. measurement gaps of different MGPs) may collide with one another in time or be close to each other in time. This may be referred to as inter-gap proximity. The risk of inter-gap collision or closeness increases with the number of MGPs in concurrent gaps or in a MUSIM scenario.

Due to collisions or close inter-gap proximity, the UE may not be able to perform measurements in all the gaps of all the configured MGPs. However, without a well-defined rule, it is unclear for both the network node (e.g. the serving BS) and the UE in which a gap occasion belongs to different MGPs whether the measurements are or can be performed or not. In addition, data scheduling is difficult or impossible among all these gap occasions, since the network node is not aware of whether the gap occasions can or cannot be used by the UE.

This may decrease the user throughput and/or outage, such as due to loss of HARQ feedback. Therefore, a new mechanism is needed to ensure that both UE and the network node are aware of the gaps used and/or unused by the UE for measurement gaps to enable the UE to selectively avoid some of the gap occasions for measurements.

Some embodiments described herein provide mechanisms for a UE to determine a scaling factor of a MG (Measurement gap) (e.g. MG scaling factor (MSF)) when the UE is configured with concurrent measurement gap patterns (MGPs), i.e., the UE is configured with at least two MGPs, which may be periodic or aperiodic or any combination thereof. The UE further uses the determined MSF for one or more operations or procedures, such as for performing measurements using the gaps, for delaying or not using gaps for certain time period, etc.

The term “scaling factor” of a MG may also be referred to as gap sharing, gap priority, gap utilization factor, carrier specific scaling factor (CSSF), etc. The determined MSF (e.g. carrier-specific scaling factor, CSSF), scales the measurement time (e.g. measurement delay or period requirement) of the measurements done by the UE using the measurement gaps.

The UE's measurements performed using gaps according to the determined MSF therefore meet one or more measurement requirements, such as measurement time, measurement period, cell identification period, measurement rate, number of identified cells to measure, measurement reporting, etc., which may further depend on the measurement configurations (e.g. number of MGPs in C-MGP, MGRP and/or MGL of each MGP in C-MGP, etc).

The measurement gap scaling factor (MSF) is based on or obtained or determined or derived by the UE based one or more conditions related to inter-gap proximity (IGP) condition associated with the gaps. Therefore, MSF depends on the one or more IGP conditions met by the measurement gaps of different MGPs configured at the UE for measurements, for example, which belong to the C-MGP.

Each IGP condition defines a relation between a first timing (e.g. T1) related to an occurrence of a first measurement gap (MG1) in a first measurement gap pattern (MGP1) and a second timing (e.g. T2) related to an occurrence of a second measurement gap (MG2) in a second measurement gap pattern (MGP2). MGP1 and MGP2 belong to a concurrent measurement gap pattern (C-MGP). The embodiments are applicable for any number of MGPs in the C-MGP.

The measurement gap sharing rule can also be referred to as an activation rule, a cancel rule, a priority rule, a muting rule etc. The sharing rule can be clearly indicated which gap occasion in the MG or MGP set is enabled/prioritized/activated or which gap occasion in the MG or MGP set is canceled/muted/deprioritized/disabled by network node. MGP set can also be referred to as a MGP group, MG group, or MG set.

According to a first embodiment, a scaling sharing solution is provided for MG to provide sharing between consecutive MGs which can belong to the same MGP with different gap offset or belong to different MGPs or different MGP sets. Examples embodiments to determine the scaling factor to be used in the UE (e.g. in different scenarios) are described below:

In a first example, a scaling factor can be provided to the UE with equal or inequal measurement opportunity among an MG or MGP set, for example, with setting of different priority of MGs or MGP sets, or different priority of different type of measurements. Examples of priority levels are: (low or high), or (low, medium and high) or multi-level (e.g. 0, 1, 2, 3 . . . . P, where 0 is lowest and P is highest or vice versa) etc.

The priority level may further be determined based on the type of measurement. In one example, the type of measurement is based on type of RAT, such as NR measurements, LTE measurements etc.

In another example, the type of measurement is based on the purpose of the measurement, such as mobility measurements (e.g. RSRP, RSRQ etc.), positioning measurements (e.g. RSTD, PRS-RSRP, UE Rx-Tx time difference) etc.

In another example, the type of measurement, such as intra-frequency measurements, inter-frequency measurements, etc., is based on type of carriers.

In another example, the scaling factor can be provided to UE with a proportion of MGs. For example, in a UE configured with measurement gaps MG1, MG2 MG3 and MG4, MG1 occupies percentage A %, MG2 occupies percentage B %, MG3 occupies percentage C % and MG4 occupies percentage D %. The scaling factor for MG1 can be KMG1=ceiling (1/A*100) and for MG2 can be KMG2=ceiling (1/B*100) and for MG3 can be KMG3=ceiling (1/C*100) and for MG4 can be KMG4=ceiling (1/D*100). Where, MG1, MG2, MG3 and MG4 belong to different MGPs within C-MGP (MGP1, MGP2, MGP3 and MGP4) respectively.

According to a second embodiment, a scaling indication solution for MGs/MGP sets provides MG indication to consecutive MGs/MGP sets, which implies an implicit sharing percentage among consecutive MGs which can be the same MGPs with different gap offset or different MGPs or different MGP sets which includes multiple MGs. The consecutive MGs/MGP sets are the gap occasions which meet the IGP condition. The MGP set is a union of multiple or at least one MGP which indicated by NW.

Examples of solution to determine the scaling indication for MGs to be used in the UE are described below:

In a first example, the network can send a signaling indication to the UE which indicates the activated or deactivated MG(s). Accordingly, the network and the UE can synchronize the scaling rule synchronously. Here, activated MGs can be referred to as enabled or prioritized MGs, and deactivated MGs can be referred to as disabled, deprioritized, or dropped MGs.

In a second example, there can be a pre-defined rule for the UE which indicates the activated or deactivated MG(s) once the MGs are meets IGP conditions. For example, if the magnitude of the difference between the MGs (the first MG, MG1 and the second MG, MG2) meets certain a IGP condition (e.g. IGP1), then MG1 and MG2 are activated or used alternatively for the measurements.

According to a third embodiment, a scaling solution (e.g., scaling sharing solution and scaling indication solution) can be adaptively changed by network implicitly or explicitly with conditions, such as IGP, time, location or network KPI, which fulfill predefined a criteria or threshold.

According to a fourth embodiment, the scaling solution can be adaptively changeable once network receives signaling of UE's capability of handling different configurations of MGs.

According to a fifth embodiment, configurations of MGs can be adaptively changeable by the network once the network receives signaling of the UE's capability or choice of handling different scaling solutions.

Some embodiments provide for scaling of measurement gaps for UE measurement procedures. Scaling measurement gaps may help to save UE power (e.g. energy, battery life etc) and/or avoid or reduce signaling overhead and/or reduce interruption due to link change, such as interruptions due to cell change (e.g. HO), beam management (e.g. beam changes etc.).

According to some embodiments, a UE may adapt the operation (e.g., transmission or reception) of one or more signals with respect to the gap scaling solutions which indicate measurements may or may not be performed in each MG of each of the configured MGPs.

In one example, the measurement adaptation or adaptive measurement or adaptive measurement procedure enables the UE, while maintaining the connection with one or more cells (e.g. PCell, PSCell etc), to perform measurements on signals with a different rate and/or periodicity and/or over different time period in a certain RRC state, such as RRC IDLE and RRC INACTIVE. In another example, the monitoring adaptation or adaptive monitoring or adaptive monitoring procedure enables the UE to monitor a downlink control channel, (e.g. for example for paging, acquiring system information etc), while maintaining the connection with NW, less frequently.

Different types or level or cases of inter-gap proximity (IGP) conditions are defined below.

For a UE configured with concurrent measurement gap patterns (C-MGP), the IGP condition defines a relation between a first timing (T1) when a one gap (e.g MG1) in MGP1 occurs and a second timing (T2) when a one gap (e.g MG2) in MGP2 occurs, where MGP1 and MGP2 belong to a C-MGP. The MG1 and MG2 may be the gaps of MGP1 and MGP2 respectively closest in time with respect to each other or consecutive MGs of the two MGPs. The parameter T1 may further comprise two or more timing related parameters, such as T11 and T12, that define when the MG1 starts and ends respectively. Also, the parameter T2 may further comprise two or more timing related parameters, such as T21 and T22, that define when the MG2 starts and ends respectively.

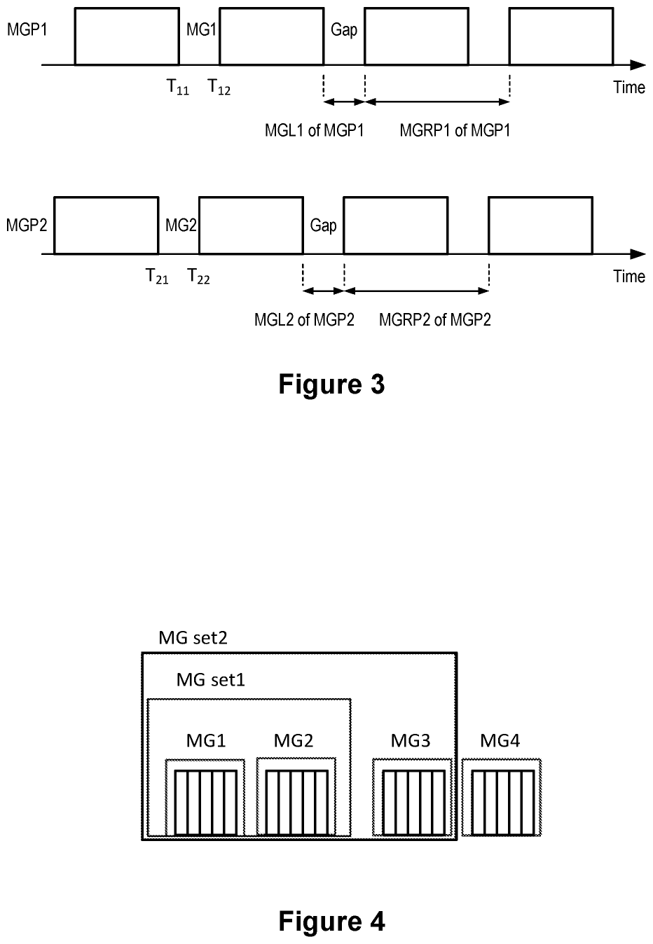

An example is shown in FIG. 3 assuming the C-MGP includes two measurement gap patterns (MGPs), MGP1 and MGP2. In the example of FIG. 3, measurement gap pattern MGP1 has a measurement gap MG1 of length MGL1 that starts at T11 and ends at T12. MGP1 has a measurement gap repetition period MGRP of MGRP1. Similarly, measurement gap pattern MGP2 has a measurement gap MG2 of length MGL2 that starts at T21 and ends at T22. MGP2 has a measurement gap repetition period MGRP of MGRP2.

IGP condition for Case 1: The configured measurement gap patterns (MGPs) within C-MGP which meets at least one of a first inter-gap proximity (IGP1) condition can be categorized into or belong to case 1 scenario.

The MGPs within C-MGP meets IGP1 condition if they meet at least one criterion for IGP1 condition. Examples of one or more criteria for the MGPs to meet the IGP1 conditions are:
IGP1 is met for the MGPs if the magnitude of the difference (T11-T21) between the starting points in time (T11 and T21) of the individual gaps is within the time duration (Δ).
IGP1 is met for the MGPs if the magnitude of the difference (T11-T22) between the starting point in time (T11) of the gap in a first MGP and the ending point in time (T22) of the gap in a second MGP is within the time duration (α).
IGP1 is met for the MGPs if the magnitude of the difference (T12-T21) between the ending point in time (T12) of the gap in a first MGP and the starting point in time (T21) of the gap in a second MGP is within the time duration (β).

IGP condition for Case 2: The configured measurement gap patterns (MGPs) within C-MGP which meets at least one of a second inter-gap proximity (IGP2) condition can be categorized into or belong to case 2 scenario.

The MGPs within C-MGP meets IGP2 condition if they meet at least one criterion for IGP2 condition. Examples of one or more criteria for the MGPs to meet the IGP2 conditions are:
IGP2 is met for the MGPs if the magnitude of the difference (T11-T21) between the starting points in time (T11 and T21) of the individual gaps is larger than a time duration (Δ1), but smaller than a time duration (Δ2).
IGP2 is met for the MGPs if the magnitude of the difference (T11-T22) between the starting point in time (T11) of the gap in a first MGP and the ending point in time (T22) of the gap in a second MGP is larger than a time duration (α1), but smaller than a time duration (α2).
IGP2 is met for the MGPs if the magnitude of the difference (T12-T21) between the ending point in time (T12) of the gap in a first MGP and the starting point in time (T21) of the gap in a second MGP is larger than a time duration (β1), but smaller than a time duration (β2).

IGP condition for Case 3: The configured measurement gap patterns (MGPs) within C-MGP which meets at least one of a third inter-gap proximity (IGP3) condition can be categorized into or belong to case 3 scenario.

The MGPs within C-MGP meets IGP2 condition if they meet at least one criterion for IGP2 condition. Examples of one or more criteria for the MGPs to meet the IGP3 conditions are:
IGP3 is met for the MGPs if the magnitude of the difference (T11-T21) between the starting points in time (T11 and T21) of the individual gaps is larger than the time duration (Δa).
IGP3 is met for the MGPs if the magnitude of the difference (T11-T22) between the starting point in time (T11) of the gap in a first MGP and the ending point in time (T22) of the gap in a second MGP is larger than the time duration (αa).
IGP3 is met for the MGPs if the magnitude of the difference (T12-T21) between the ending point in time (T12) of the gap in a first MGP and the starting point in time (T21) of the gap in a second MGP is larger than the time duration (βa).

### Measurement Gap Pattern Sets (MGP Sets)

One aspect of the embodiments is that a group of MGs can be categorized as a MG set. The term “set” may be written as union and any wording to express those MGs are treated as combination of those MGs.

Accordingly, for example, MG set Y may include MG_Y1, MG_Y2, MG_Y3, etc., and MG set Z may include MG_Z1, MG_Z2, MG_Z3, etc. As a further example, MG set Z may include MG_Z1, MG_Z2, MGP_Z3, etc. and MG set Y1, MGP set Y2, MGP set Y3, etc. That is, an MG set may include MGs and MG sets. The gap set can be exclusive for all the configured MGs.

A group of MGs and a group of MG sets can be categorized as a multi-level hierarchy of MG sets. If all items in one MG set are single MGs without any MG sets, the MG is level 1. In one MG set, If the highest level of component MG sets is level N, then the MG is level N+1.

A rule to group the MGs into one MG set can be based on whether the magnitude of the difference between two MGs meets the inter-gap proximity condition IGP1 or IGP2.

For example, MGs may be grouped in a set: (1) if the magnitude of the difference between the starting points in time of the first gap and last gap meets IGP1 or IGP2, or (2) if the magnitude of the difference between the starting point in time of the gap in a first MGP and the ending point in time of the gap in a last MGP meet the IGP1 or IGP2, or (3) if the magnitude of the difference between the ending point in time of the gap in a first MGP and the starting point in time of the gap in a last MGP meet the IGP1 or IGP2.

The network can indicate the MGs in one MG set based on measurement object (MO) priority or MG priority or based on an indication/suggestion by the UE. The priority rule can be pre-defined or indicated by UE or implement by NW itself.

One specific example of the priority rule can be that the measurement gap for positioning measurement has a higher priority than other measurement gap for RS based measurements. Another specific example can be that the measurement gap for measurements in Idle mode cell reselection in MUSIM has lower priority than other measurement gap for RS based measurements in CONNECTED mode.

A third specific example can be that the gap for handover (HO) measurements/Paging monitoring/RACH transmission/SI acquisition has higher priority than the gap for measurements.

A fourth specific example can be that the gap for PCell L3 measurements has higher priority than the gap for inter-frequency/inter-RAT measurements.

An example is shown in FIG. 4, where a total of 4 MGs can be categorized with different levels of MG sets:
MG set1 includes MG1+MG2; where MG1 and MG2 are at same level 1.
MG set2 includes MG set1+MG3. where MG set1 and MG3 are at same level 2.
MG set2 and MG4 are at same level 3.

In another aspect, a group of measurement gap patterns (MGPs) can be categorized as a MGP set. For example, an MGP set YP may include MGP_YP1, MGP_YP2, MGP_YP3, etc. As a further example, MGP set ZP may include MGP_ZP1, MG_ZP2, MGP_ZP3, etc. and MGP set YP1, MGP set YP2, MGP set YP3, etc. That is, an MGP set may include MGPs and MGP sets.

In one example, the gap set can be exclusive for all the configured MGPs.

A group of MGs and a group of MG sets can be categorized as a multi-level hierarchy of MGP sets. If all items in one MGP set are single MGPs without any MGP set, the MG is level 1. In one MGP set, If the highest level of component MGP set is level N, then the MGP is level N+1.

A rule to group the MGPs into one MGP set can be based on whether the magnitude of the difference between two MGPs meets the IGP1 or IGP2 at least in one occasions/periodicity.

For example, MGPs may be grouped into a set (1) if the magnitude of the difference between the starting points in time of the first gap and last gap meet the IGP1 or IGP2 at least in one occasions/periodicity, or (2) if the magnitude of the difference between the starting point in time of the gap in a first MGP and the ending point in time of the gap in a last MGP meet the IGP1 or IGP2 at least in one occasions/periodicity, or (3) if the magnitude of the difference between the ending point in time of the gap in a first MGP and the starting point in time of the gap in a last MGP meet the IGP1 or IGP2 at least in one occasions/periodicity.

The network can indicate the MGPs in one MGP set based on MGP priority or based on an indication/suggestion by the UE. The priority rule can be pre-defined or indicated by the UE or implemented by the network itself.

One specific example of the priority rule can be that the measurement gap for positioning measurement has higher priority than other measurement gap for RS based measurements.

Another specific example can be the measurement gap for measurements in Idle mode cell reselection in MUSIM has lower priority than other measurement gap for RS based measurements in CONNECTED mode.

A third specific example can be the gap for HO measurements/Paging monitoring/RACH transmission/SI acquisition has higher priority than the gap for measurements.

A fourth specific example can be the gap for PCell L3 measurements has higher priority than the gap for inter-frequency/inter-RAT measurements.

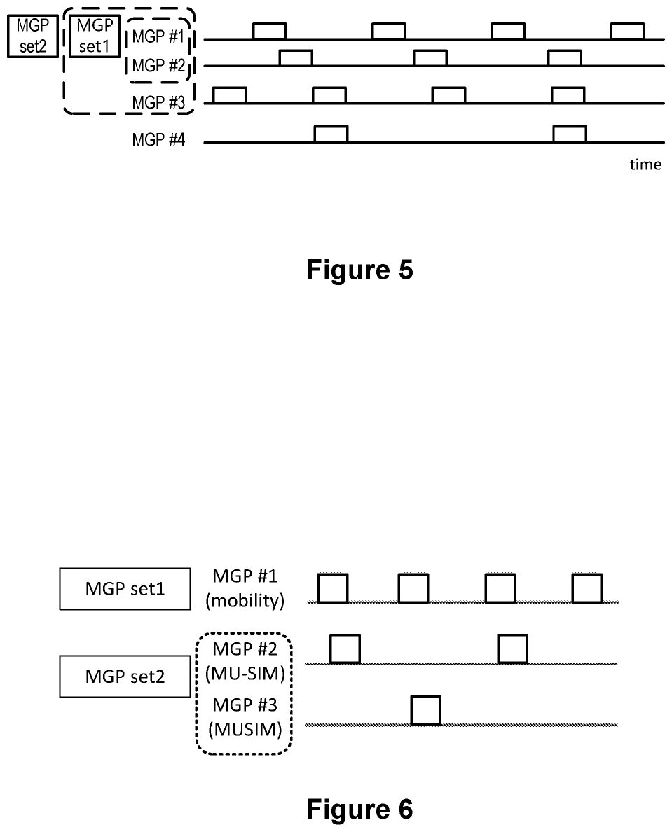

An example is shown in FIG. 5, where a total of 4 MGPs can be categorized with different level of MGP sets as follows:
MGP set1 includes MGP1+MGP2; where MGP1 and MGP2 are at same level 1.
MGP set2 includes MGP set1+MGP3; where MGP set1 and MGP3 are at same level 2.
MGP set2 and MGP4 are at the same level 3.

A gap scaling indication according to some embodiments can also support multiple MGP sets. For example, a gap scaling indication can be applied for MUSIM gaps. Currently, the traditional gap is applied for CONNECTED mode mobility, or positioning measurements.

The MG set can be grouped based on the gap usage indicated by the network.

When additional new gaps are introduced for MUSIM, traditional MGs can be considered as an MGP set for CONNECTED mobility. The new MUSIM can be considered as an MGP set.

This is illustrated in FIG. 6, which illustrates a scaling solution for MG which provides a sharing factor between consecutive MGs of different MGPs. In particular, FIG. 6 shows a MGP set1 including MG1 for mobility and MGP set2 including MG2 and MG3 for MUSIM.

The network can further indicate the gap scaling indication based on the MGP sets. For example, the gap scaling indication can be used to indicate which group of gaps shall be prioritized once overlap occurs.

A method according to a first embodiment includes a scaling sharing solution for MG which provides a sharing factor between consecutive MGs of different MGPs

The measurement delay requirement for each measurement cell per frequency layer may be expressed by a general function as follows:

Tmeas=f1(Ksharing,SMTC period,DRX cycle)

where Kscaling is a scaling/sharing factor or a set or sets of a scaling/sharing factor. The SMTC period is the SS/PBCH Block Measurement Timing Configuration and the DRX cycle is the discontinuous reception cycle. The SMTC period and DRX cycle usually define the measurement gap length. A scaling factor is applied according to some embodiments to change the length of the measurement gap to avoid overlap with other measurement gaps.

If Kscaling=M, UE shall perform measurements in the MG per f2(M) occasions/periodicity based on SMTC period, DRX cycle, where f2 is formula involving M to calculate the exact number.

In an example, Kscaling=1, UE shall perform measurement per 1 MG occasions/periodicity. In another example, Kscaling=2, UE shall perform measurement per 2 MG occasions/periodicity. Kscaling can be cascaded from 1 stage up to N stages to cover each or several level of MG or MG sets.

For a MG, the generation of Kscaling by multi-stage can be expressed as:
Kscaling=f3 (Kscaling1), for only one stage
Kscaling=f4 (Kscaling1, Kscaling2), for two stages
Kscaling=f5 (Kscaling1, Kscaling2, Kscaling3 . . . . KscalingN), for N stages.

To scale each MG flexibly, the mapping between cascading Kscaling and MG sets may be expressed as follows:
An example is that KscalingX shall scale MG setsY and MGs and MG sets which level is lower than Y, where X is stage index of scaling and Y is level of set.
Another example is KscalingX+1 shall scale MG setsY+1 and MGs and MG sets which level is lower than Y+1, and so on.
Generally, KscalingX+ΔX shall scale MG setsY+ΔY and MGs and MG sets which level is lower than Y+ΔY, where ΔX can be equal or inequal to ΔY.

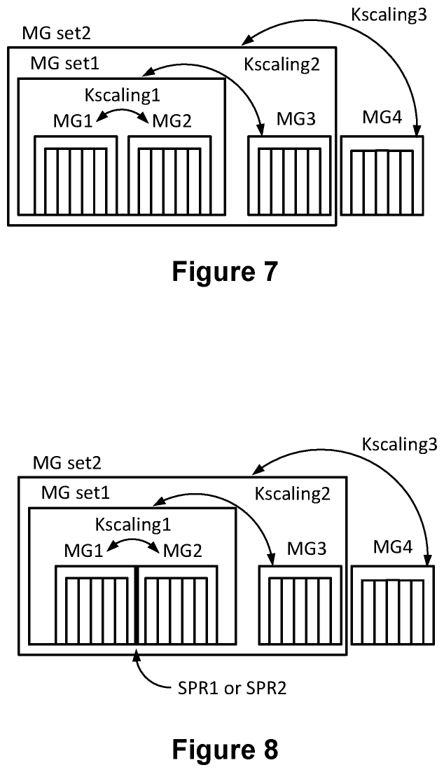

Taking FIG. 7 as an example, the mapping relationship is:
Kscaling1 is scaling sharing between MG1 and MG2, because MG1 and MG2 are at the same level1.
Kscaling2 is scaling sharing between MG set1 and MG3, because MG set1 and MG3 are at the same level2.
Kscaling3 is scaling sharing between MG set2 and MG4, because MG set2 and MG4 are at the same level3.

Following above mapping, each MG can get its scaling factor. For example, for MG1 and MG2, Kscaling can be defined as this format:
Kscaling1=1; Kscaling2=1; Kscaling3=2.

This implies that the UE shall perform measurements in MG1 1 time per Kscaling=Kscaling1*Kscaling2*Kscaling3=1*1*2=2 occasions/periodicities.

For MG3, Kscaling can be defined as this format:
Kscaling2=1; Kscaling3=1.

This implies that the UE shall perform measurements in MG3 1 time per Kscaling-Kscaling2*Kscaling3=1*1=1 occasions/periodicities.

For MG4, Kscaling can be defined as this format:
Kscaling3=1.

This implies that the UE shall perform measurements in MG4 1 time per Kscaling=Kscaling3=1 occasions/periodicities.

It shall be noted that the format can be varied in implementation, but the format target shall indicate which Kscaling and Kscaling stage the MG shall utilize to get scaling factor.

It shall be noted that if MGs or MGs set meet IGP1 or IGP2, the scaling factor of this stage of those MGs or MGs must be more than 1. This indicates MGs or MGs set which meet IGP1 or IGP2 must be scaled.

The example in FIG. 8 shows a possibility that MG1 and MG2 meets IGP1 or IGP2. In this case, Kscaling1 cannot be set to 1.

For MG1 and MG2, Kscaling can be defined as this format:
Kscaling1=2; Kscaling2=1; Kscaling3=1.

This implies that MG1 shall be measured 1 time per Kscaling-Kscaling1*Kscaling2* Kscaling3=2*1*1=2 occasions/periodicities.

An equal scaling scheme indicates that all Kscaling of all MGs are the same. An unequal scaling scheme indicates that all Kscaling of all MGs are not the same.

An equal scaling scheme or unequal scaling scheme is configurable via network signaling. Also, due to mutli-stage of scaling factors and multi-level MGs, the equal scaling scheme or unequal scaling scheme can be treated as per stage/level or entirely.

If a MG's KscalingX=A and another MG's KscalingX=B, the scaling scheme is unequal at stage X.

If a MG's Kscaling-KscalingX (=A)*KscalingY (=B)=A*B and another MG's Kscaling=KscalingX (=B)*KscalingY(=A)-B*A, the scaling scheme is unequal at stage X or Y. but the scaling scheme is equal overall.

Regarding the equal scaling scheme, in one example, Kscaling can be 1 if all the MGs meet the IGP3. That implies equal scaling opportunity because all MGs are measured per occasion/periodicity.

In another example, Kscaling can be N when the number of MGs is N and all MGs have equal sharing opportunity. For example, in a case with a total of 2 MGs, in a first periodicity, measurement occurs in MG1; in a second periodicity; measurement occurs in MG2; in a third periodicity, measurement occurs in MG1 again, and so on.

Regarding the inequal scaling scheme, in one example, Kscaling can be different factors (Ni, i=1, 2, . . . ) when configured MGs have inequal sharing opportunity.

For example, when the network configures 3 MGPs (MGP1, MGP2 and MGP3), the factors may be:
N1 for MG1 belonging to MGP1
N2 for MG2 belonging to MGP2
N3 for MG3 belonging to MGP3

MG1 has higher priority in the first periodicity, and measurement occurs in MG1. In a second periodicity, measurement occurs in MG1 and MG2. In a third periodicity, measurement occurs in MG1 again, and so on. In this case, N1=1, N2=N3=2.

The priority can be indicated by the UE, determined based on a pre-defined rule, or be up to NW implementation.

In another example, the network can transmit the signalling to the UE to indicate the percentage of each MG, where, X1+X2+X3+X4=100. An example is shown in Table 2.

TABLE 2
Scaling factor per MG by percentage

| MG1 (%) | MG2 (%) | MG3 (%) | MG4 (%) |
|---|---|---|---|
| Equal splitting | Equal splitting | Equal splitting | Equal splitting |
| X1 | X2 | X3 | X4 |

A method according to a second embodiment for a scaling indication solution for MG provides sharing between consecutive MGs.

In an embodiment of a gap indication rule, the network node indicates to the UE the used MGs and the unused MGs in each occasion/periodicity, and UE follows the indications.

According to one aspect of an embodiment of a gap indication rule is that both the network node (e.g. the serving base station) and the UE will have a clear common understanding through indication by the network node to UE in each gap collision happens. Signaling indicates the MG which the UE shall and will use in each gap collision in each occasion/periodicity.

An example is that network sends signaling of rule of indication to UE, accordingly network and UE can synchronize the scaling rule synchronously.

On the one hand, the UE can easily perform the measurements based on the NW's gap indication. On the other hand, the network can schedule the data on the unused gap occasion when collision happens.

It can be seen that there may be uncertainty for the UE's behavior on each gap occasion for a sharing rule according to priority. This means that it is not possible to further utilize the gap instance which is not used for measurements by UE. On the contrary, after clear indication, data scheduling on the unused gap duration can be expected for gap indication rule.

Another aspect of the embodiment of gap indication has the benefits for flexible gap configuration. Setting priority on MG will always prioritize one gap when overlapping happens. However, if measurements are always prioritized for one gap, there is no benefit for configuring concurrent gaps. Compared with a priority rule, an indication rule and a sharing rule can provide more flexibility and gap utilization.

Furthermore, a gap indication rule is a general type of sharing rule and priority rule and can transform to a sharing rule and priority rule easily.

### Gap Indication Rule for MGP(s) Sets

Another embodiment of a gap indication rule is that a network node indicates to the UE the used MGP set and the unused MGP set in each occasion/periodicity based on MGP sets, and UE follows the indications. The MGP set can be believed as a union of MGs occasions.

Signaling indicates the MGP set which UE shall and will use for each gap collision in each occasion/periodicity. Signaling further indicate the MG in the MGP set which UE shall and will use in each gap collision can be further indicated by gap indication for MGs in the MGP sets.

It can be seen that the indication can be based on the MGP sets which includes multiple MGs. The MGP sets is multiple or at least one MGs which are grouped based on MG's usage, such as MU-SIM, positioning, etc. The network will initially indicate which MGP set will be used once the collision happens, for example, based on MGP set priority or MGP set usage. The network can further indicate UE the used MGs and the unused MGs in each occasion/periodicity in one MG set when there are multiple gaps in one MG set.

One aspect of the embodiment is that signaling by network comprises information how each MG is disable or enabled in different measurement occasion or periodicity.

Another aspect of the embodiment comprises a method in a UE following the signaling to setup measurements using MGs accordingly.

Below are three typical indication instances. More practical indication instances are not limited but shall be covered by embodiments of gap indication.

All these embodiments can also be extended to MGP sets. The network signalling can be transmitted based on the MGP sets.

### First Scaling Indication Embodiment

A embodiment of signalling solution on Gap collision for IGP3 is that a 4-bits map can be used as signaling content to define a gap indication rule as follow. The network can configure an indication map to the UE together with each gap to indicate the priority of this gap if a collision happens between gaps.

For example, ‘0’ means the gap will be disabled, ‘1’ means the gap will be enabled. Assuming the Signaling indication #8 i.e. signaling ‘1000’ is configured together with MG1, in the 1st measurement occasion or periodicity, the MG1 will be enable i.e. measurement occurs in MG1. In the 2nd-4th measurement occasions or periodicities, MG1 will be disabled i.e. no measurement in MG1.

After that, UE will repeat the sequence. The gap indication rule can be considered as a network-controlled gap sharing rule. In the other words, the network knows and acknowledges which MGs are used and which MGs are not used accurately.

The measurement occasions of ‘first’ MGP and the measurement occasions of ‘other’ MGPs can be determined by a reference timing (e.g. SFN of a serving cell) or other approach that network and UE can use for synchronize with the UE and account a bit map of MG repeatedly.

For example, the bit map can be a 4 bit bitmap. The number of the bits in the bit-ap can be different number of MGs and/or configuration of MGs.

The bitmap can be signaled using RRC parameters with optional MAC CE or DCI indications, or other signaling mechanisms.

Table 3 shows an example of a signaling indication and indication rule as described above. The name and format may be different for different gap configurations. But the key embodiment of the solution is that the signaling of the bitmap by network node comprises information how each MG is disable or enabled in different measurement occasion or periodicity.

TABLE 3
Signaling indication example comprising
a bit map for MGs for each MGP

| Signalling indication | Indication rule |
|---|---|
| #0 | 0000 |
| #1 | 0001 |
| #2 | 0010 |
| #3 | 0011 |
| #4 | 0100 |
| #5 | 0101 |
| #6 | 0110 |
| #7 | 0111 |
| #8 | 1000 |
| #9 | 1001 |
| #10 | 1010 |
| #11 | 1011 |
| #12 | 1100 |
| #13 | 1101 |
| #14 | 1110 |
| #15 | 1111 |

A general example of signalling solution on Gap collision for IGP1,2 is to add limitation when 2 MGs meet IGP1 or IGP2.

The example shown in Table 3 can be spread to a 2-D matrix. An example has 4 MGs is shown in Table 4. For each occasion, the signaling can be ‘1’ or ‘0’ and the full signaling of a MG is a 4-bits map.

TABLE 4
Signaling indication in occasions

| | Occasion1 | Occasion2 | Occasion3 | Occasion4 |
|---|---|---|---|---|
| MG1 | 1/0 | 1/0 | 1/0 | 1/0 |
| MG2 | 1/0 | 1/0 | 1/0 | 1/0 |
| MG3 | 1/0 | 1/0 | 1/0 | 1/0 |
| MG4 | 1/0 | 1/0 | 1/0 | 1/0 |

If MG1 and MG2 meet IGP1 or IGP2, then the signaling in occasions when they collide shall follow different rule. For example, referring to Table 5, in occasion1, signaling for MG1 is X, X can be ‘1’ or ‘0’, then signaling for MG2 is Y, Y can be ‘1’ or ‘0’. And X≠Y unless both are ‘0’. In occasion2, signaling for MG1 is Y (or X), Y (or X) can be ‘1’ or ‘0’, then signaling for MG2 is X (or Y if MG1 is X), X (or Y if MG1 is X) can be ‘1’ or ‘0’. And X≠Y unless both are ‘0’. In this way, the full signaling of MG1 can be ‘1011’ and signaling of MG2 is ‘0111’.

TABLE 5
Signaling indication in occasions when meeting IGP1 and IGP2

| | Occasion1 | Occasion2 | Occasion3 | Occasion4 |
|---|---|---|---|---|
| MG1 | X | Y(X) | 1/0 | 1/0 |
| MG2 | Y | X(Y) | 1/0 | 1/0 |
| MG3 | 1/0 | 1/0 | 1/0 | 1/0 |
| MG4 | 1/0 | 1/0 | 1/0 | 1/0 |

### Second Scaling Indication Embodiment

Another alternative embodiment which can be used in IGP1,2,3 is that a bit map can be used as signaling content to define a gap indication rule as follows. The network can configure an indication map to UE together with one of the gaps to indicate whether to prioritize this gap if a collision happens between gaps. UE will repeat performing the measurements based on the order of the MG indication.

For example, ‘1’ means the MG1 will be enabled, ‘2’ means the MG2 will be enabled, ‘3’ means the gap MG3 will be enabled, ‘4’ means the gap index MG4 will be enabled.

After that, UE will repeat the sequence. gap indication rule can be believed as a network-controlled gap sharing rule, in the other word, network knows and acknowledges which MGs are used and which MGs are not used accurately.

Following is an example in which the signaling indication ‘1234’ is configured. The embodiment implies equal sharing for all MGs:
The UE will perform measurements in MG1 in the first occasion/periodicity.
The UE will perform measurements in MG2 in the second occasion/periodicity.
The UE will perform measurements in MG3 in the third occasion/periodicity.
The UE will perform measurements in MG4 in the fourth occasion/periodicity.

### Third Scaling Indication Embodiment

In another aspect of the embodiment, the scaling indication can be applied to gap collision only. For example, the gap occasions if MGPs meet the IGP1,2, the network can configure an indication map to UE together with one of the gaps to indicate whether to prioritize this gap if a collision happens between gaps.

For example, if the colliding MGs are MG1 and MG2, ‘0’ means the gap will be disabled, ‘1’ means the gap will be enabled. Assuming the signalling ‘1000’ is configured together with MG1, in the 1st gap collision occasion, the MG1 will be prioritized. In the 2nd-4th gap collision occasions, MG2 will be prioritized. After that, UE will repeat the gap priority sequence. At the same time, indication rule implies priority and sharing percentage. (For example, only configures the indication index #0 or #15).

An aspect carried by the indication rule is, regarding some gap occasions will be disabled, data scheduling on the disabled gap occasions is permitted since both NW and UE have the same understanding on which gap occasion shall be disabled.

Different with legacy NR data scheduling issue due to missing MOs' configuration, one of the important reasons to indication the gap occasions is to avoid the situation in which UE can't receive the DL or/and transmit the UL during a long period. Thus, data scheduling is expected on the dropping gap occasions and the exact framework of data scheduling may vary along with different cases of MG configurations in above.

The general gap indication rule determine which gap shall be keep and the condition to apply the rule, therefore the indication rule can be applied to all of the FO/FPO/PFO/PPO/FNO cases.

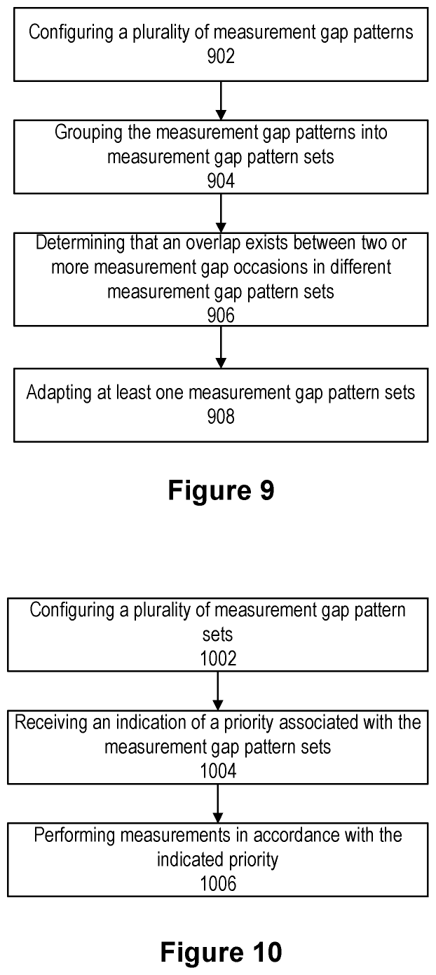

Referring to FIG. 9, a method performed by a user equipment (UE) includes configuring (block 902) a plurality of measurement gap patterns for performing measurements during measurement gaps, grouping (block 904) the measurement gap patterns into measurement gap pattern sets, determining (block 906) that a collision exists between two or more measurement occasions in different measurement gap pattern sets, and adapting (block 908) at least one of the measurement gap pattern sets in response to determining that the collision exists.

Referring to FIG. 10, a method performed by a UE includes configuring (block 1002) a plurality of measurement gap pattern sets for performing measurements during measurement gaps, receiving (block 1004) an indication from a network node of a priority associated with the plurality of measurement gap pattern sets, and performing (block 1006) measurements in accordance with the indicated priority.

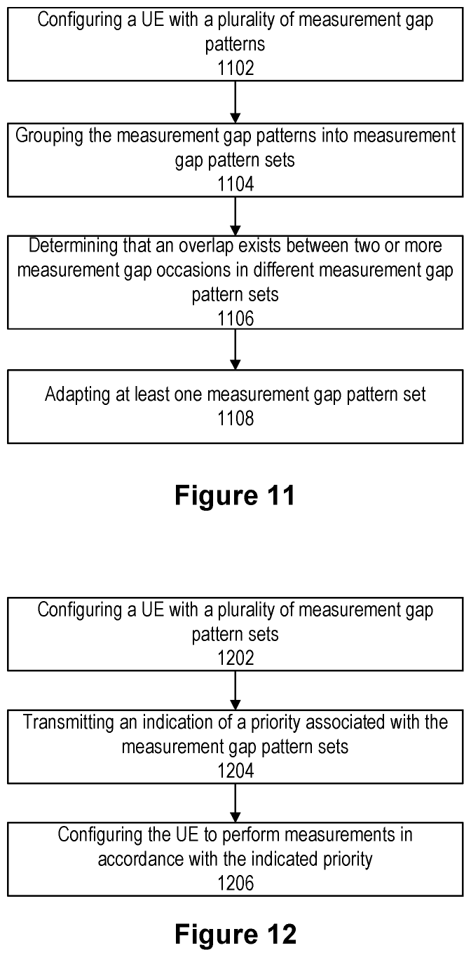

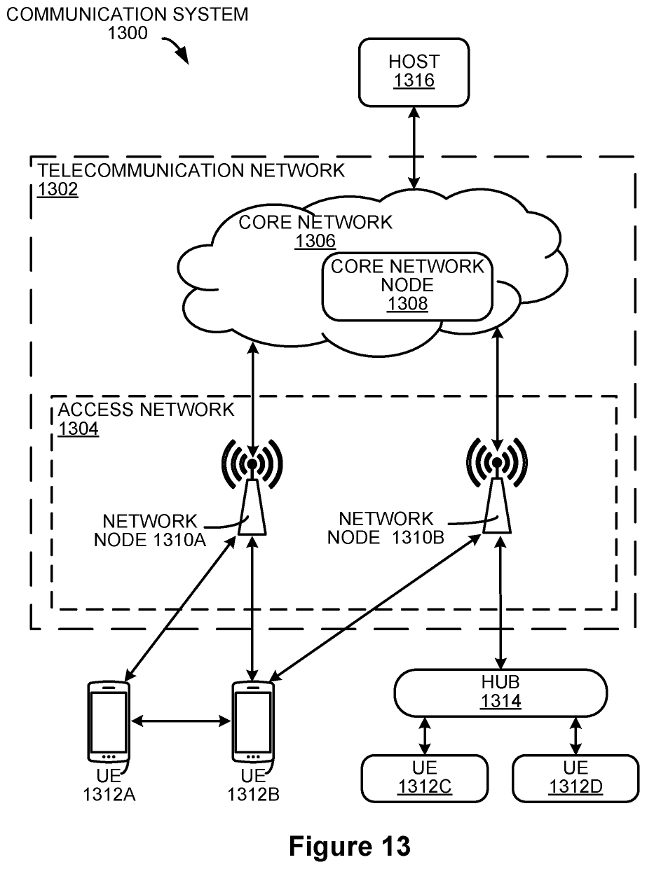

Operations of a RAN node, such as network nodes 1310a and 1310b shown in FIG. 13, will now be discussed with reference to the flow charts of FIGS. 11 and 12 according to some embodiments of inventive concepts.

Referring to FIG. 11, a method performed by a network node includes configuring (block 1102) a user equipment with a plurality of measurement gap patterns for performing measurements during measurement gaps, grouping (block 1104) the measurement gap patterns into measurement gap pattern sets, determining (block 1106) that a collision exists between two or more measurement gap occasions in different measurement gap pattern sets, and adapting (block 1108) at least one of the measurement gap pattern sets in response to determining that the collision exists.

Referring to FIG. 12, a method performed by a network node includes configuring (block 1202) a user equipment with a plurality of measurement gap pattern sets for performing measurements during measurement gaps, transmitting (block 1204) an indication to the user equipment of a priority associated with the plurality of measurement gap pattern sets, and configuring (block 1206) the user to perform measurements in accordance with the indicated priority.

### Additional Embodiments

FIG. 13 shows an example of a communication system 1300 in accordance with some embodiments.

In the example, the communication system 1300 includes a telecommunication network 1302 that includes an access network 1304, such as a radio access network (RAN), and a core network 1306, which includes one or more core network nodes 1308. The access network 1304 includes one or more access network nodes, such as network nodes 1310a and 1310b (one or more of which may be generally referred to as network nodes 1310), or any other similar 3rd Generation Partnership Project (3GPP) access node or non-3GPP access point. The network nodes 1310 facilitate direct or indirect connection of user equipment (UE), such as by connecting UEs 1312a, 1312b, 1312c, and 1312d (one or more of which may be generally referred to as UEs 1312) to the core network 1306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1300 may include any number of wired or wireless networks, network nodes, UEs, and/or any other components or systems that may facilitate or participate in the communication of data and/or signals whether via wired or wireless connections. The communication system 1300 may include and/or interface with any type of communication, telecommunication, data, cellular, radio network, and/or other similar type of system.

The UEs 1312 may be any of a wide variety of communication devices, including wireless devices arranged, configured, and/or operable to communicate wirelessly with the network nodes 1310 and other communication devices. Similarly, the network nodes 1310 are arranged, capable, configured, and/or operable to communicate directly or indirectly with the UEs 1312 and/or with other network nodes or equipment in the telecommunication network 1302 to enable and/or provide network access, such as wireless network access, and/or to perform other functions, such as administration in the telecommunication network 1302.

In the depicted example, the core network 1306 connects the network nodes 1310 to one or more hosts, such as host 1316. These connections may be direct or indirect via one or more intermediary networks or devices. In other examples, network nodes may be directly coupled to hosts. The core network 1306 includes one more core network nodes (e.g., core network node 1308) that are structured with hardware and software components. Features of these components may be substantially similar to those described with respect to the UEs, network nodes, and/or hosts, such that the descriptions thereof are generally applicable to the corresponding components of the core network node 1308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1316 may be under the ownership or control of a service provider other than an operator or provider of the access network 1304 and/or the telecommunication network 1302, and may be operated by the service provider or on behalf of the service provider. The host 1316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1300 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1302 is a cellular network that implements 3GPP standardized features. Accordingly, the telecommunications network 1302 may support network slicing to provide different logical networks to different devices that are connected to the telecommunication network 1302. For example, the telecommunications network 1302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1312 are configured to transmit and/or receive information without direct human interaction. For instance, a UE may be designed to transmit information to the access network 1304 on a predetermined schedule, when triggered by an internal or external event, or in response to requests from the access network 1304. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1314 communicates with the access network 1304 to facilitate indirect communication between one or more UEs (e.g., UE 1312c and/or 1312d) and network nodes (e.g., network node 1310b). In some examples, the hub 1314 may be a controller, router, content source and analytics, or any of the other communication devices described herein regarding UEs. For example, the hub 1314 may be a broadband router enabling access to the core network 1306 for the UEs. As another example, the hub 1314 may be a controller that sends commands or instructions to one or more actuators in the UEs. Commands or instructions may be received from the UEs, network nodes 1310, or by executable code, script, process, or other instructions in the hub 1314. As another example, the hub 1314 may be a data collector that acts as temporary storage for UE data and, in some embodiments, may perform analysis or other processing of the data. As another example, the hub 1314 may be a content source. For example, for a UE that is a VR headset, display, loudspeaker or other media delivery device, the hub 1314 may retrieve VR assets, video, audio, or other media or data related to sensory information via a network node, which the hub 1314 then provides to the UE either directly, after performing local processing, and/or after adding additional local content. In still another example, the hub 1314 acts as a proxy server or orchestrator for the UEs, in particular in if one or more of the UEs are low energy IoT devices.

The hub 1314 may have a constant/persistent or intermittent connection to the network node 1310b. The hub 1314 may also allow for a different communication scheme and/or schedule between the hub 1314 and UEs (e.g., UE 1312c and/or 1312d), and between the hub 1314 and the core network 1306. In other examples, the hub 1314 is connected to the core network 1306 and/or one or more UEs via a wired connection. Moreover, the hub 1314 may be configured to connect to an M2M service provider over the access network 1304 and/or to another UE over a direct connection. In some scenarios, UEs may establish a wireless connection with the network nodes 1310 while still connected via the hub 1314 via a wired or wireless connection. In some embodiments, the hub 1314 may be a dedicated hub—that is, a hub whose primary function is to route communications to/from the UEs from/to the network node 1310b. In other embodiments, the hub 1314 may be a non-dedicated hub—that is, a device which is capable of operating to route communications between the UEs and network node 1310b, but which is additionally capable of operating as a communication start and/or end point for certain data channels.

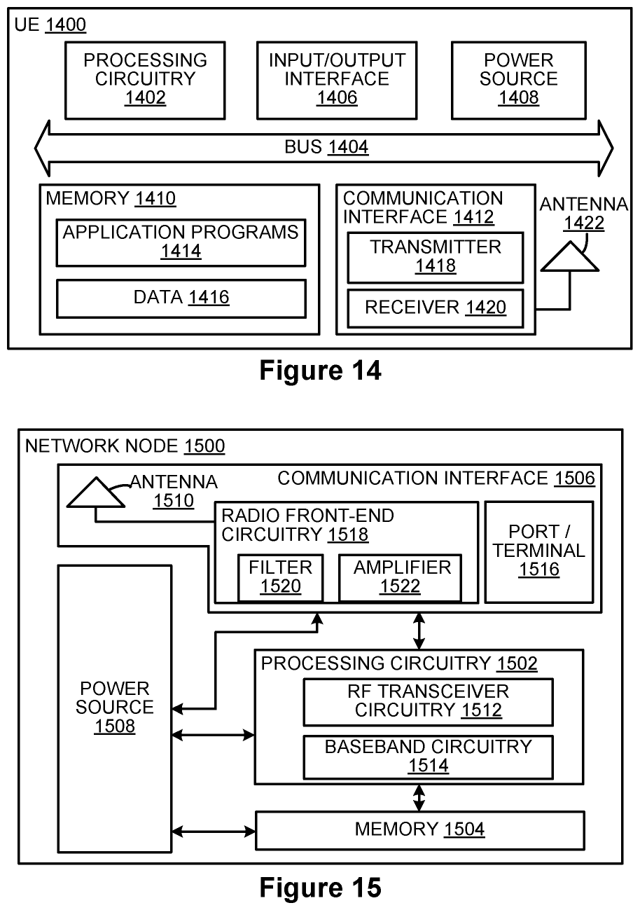

FIG. 14 shows a UE 1400 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1400 includes processing circuitry 1402 that is operatively coupled via a bus 1404 to an input/output interface 1406, a power source 1408, a memory 1410, a communication interface 1412, and/or any other component, or any combination thereof. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

The processing circuitry 1402 is configured to process instructions and data and may be configured to implement any sequential state machine operative to execute instructions stored as machine-readable computer programs in the memory 1410. The processing circuitry 1402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1402 may include multiple central processing units (CPUs).

In the example, the input/output interface 1406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1408 is structured as a battery or battery pack. Other types of power sources, such as an external power source (e.g., an electricity outlet), photovoltaic device, or power cell, may be used. The power source 1408 may further include power circuitry for delivering power from the power source 1408 itself, and/or an external power source, to the various parts of the UE 1400 via input circuitry or an interface such as an electrical power cable. Delivering power may be, for example, for charging of the power source 1408. Power circuitry may perform any formatting, converting, or other modification to the power from the power source 1408 to make the power suitable for the respective components of the UE 1400 to which power is supplied.

The memory 1410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1410 includes one or more application programs 1414, such as an operating system, web browser application, a widget, gadget engine, or other application, and corresponding data 1416. The memory 1410 may store, for use by the UE 1400, any of a variety of various operating systems or combinations of operating systems.

The memory 1410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1410 may allow the UE 1400 to access instructions, application programs and the like, stored on transitory or non-transitory memory media, to off-load data, or to upload data. An article of manufacture, such as one utilizing a communication system may be tangibly embodied as or in the memory 1410, which may be or comprise a device-readable storage medium.

The processing circuitry 1402 may be configured to communicate with an access network or other network using the communication interface 1412. The communication interface 1412 may comprise one or more communication subsystems and may include or be communicatively coupled to an antenna 1422. The communication interface 1412 may include one or more transceivers used to communicate, such as by communicating with one or more remote transceivers of another device capable of wireless communication (e.g., another UE or a network node in an access network). Each transceiver may include a transmitter 1418 and/or a receiver 1420 appropriate to provide network communications (e.g., optical, electrical, frequency allocations, and so forth). Moreover, the transmitter 1418 and receiver 1420 may be coupled to one or more antennas (e.g., antenna 1422) and may share circuit components, software or firmware, or alternatively be implemented separately.

In the illustrated embodiment, communication functions of the communication interface 1412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1400 shown in FIG. 14.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 15 shows a network node 1500 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1500 includes a processing circuitry 1502, a memory 1504, a communication interface 1506, and a power source 1508. The network node 1500 may be composed of multiple physically separate components (e.g., a NodeB component and a RNC component, or a BTS component and a BSC component, etc.), which may each have their own respective components. In certain scenarios in which the network node 1500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1500 may be configured to support multiple radio access technologies (RATs). In such embodiments, some components may be duplicated (e.g., separate memory 1504 for different RATs) and some components may be reused (e.g., a same antenna 1510 may be shared by different RATs). The network node 1500 may also include multiple sets of the various illustrated components for different wireless technologies integrated into network node 1500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1500.

The processing circuitry 1502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1500 components, such as the memory 1504, to provide network node 1500 functionality.

In some embodiments, the processing circuitry 1502 includes a system on a chip (SOC). In some embodiments, the processing circuitry 1502 includes one or more of radio frequency (RF) transceiver circuitry 1512 and baseband processing circuitry 1514. In some embodiments, the radio frequency (RF) transceiver circuitry 1512 and the baseband processing circuitry 1514 may be on separate chips (or sets of chips), boards, or units, such as radio units and digital units. In alternative embodiments, part or all of RF transceiver circuitry 1512 and baseband processing circuitry 1514 may be on the same chip or set of chips, boards, or units.

The memory 1504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1502. The memory 1504 may store any suitable instructions, data, or information, including a computer program, software, an application including one or more of logic, rules, code, tables, and/or other instructions capable of being executed by the processing circuitry 1502 and utilized by the network node 1500. The memory 1504 may be used to store any calculations made by the processing circuitry 1502 and/or any data received via the communication interface 1506. In some embodiments, the processing circuitry 1502 and memory 1504 is integrated.

The communication interface 1506 is used in wired or wireless communication of signaling and/or data between a network node, access network, and/or UE. As illustrated, the communication interface 1506 comprises port(s)/terminal(s) 1516 to send and receive data, for example to and from a network over a wired connection. The communication interface 1506 also includes radio front-end circuitry 1518 that may be coupled to, or in certain embodiments a part of, the antenna 1510. Radio front-end circuitry 1518 comprises filters 1520 and amplifiers 1522. The radio front-end circuitry 1518 may be connected to an antenna 1510 and processing circuitry 1502. The radio front-end circuitry may be configured to condition signals communicated between antenna 1510 and processing circuitry 1502. The radio front-end circuitry 1518 may receive digital data that is to be sent out to other network nodes or UEs via a wireless connection. The radio front-end circuitry 1518 may convert the digital data into a radio signal having the appropriate channel and bandwidth parameters using a combination of filters 1520 and/or amplifiers 1522. The radio signal may then be transmitted via the antenna 1510. Similarly, when receiving data, the antenna 1510 may collect radio signals which are then converted into digital data by the radio front-end circuitry 1518. The digital data may be passed to the processing circuitry 1502. In other embodiments, the communication interface may comprise different components and/or different combinations of components.

In certain alternative embodiments, the network node 1500 does not include separate radio front-end circuitry 1518, instead, the processing circuitry 1502 includes radio front-end circuitry and is connected to the antenna 1510. Similarly, in some embodiments, all or some of the RF transceiver circuitry 1512 is part of the communication interface 1506. In still other embodiments, the communication interface 1506 includes one or more ports or terminals 1516, the radio front-end circuitry 1518, and the RF transceiver circuitry 1512, as part of a radio unit (not shown), and the communication interface 1506 communicates with the baseband processing circuitry 1514, which is part of a digital unit (not shown).

The antenna 1510 may include one or more antennas, or antenna arrays, configured to send and/or receive wireless signals. The antenna 1510 may be coupled to the radio front-end circuitry 1518 and may be any type of antenna capable of transmitting and receiving data and/or signals wirelessly. In certain embodiments, the antenna 1510 is separate from the network node 1500 and connectable to the network node 1500 through an interface or port.

The antenna 1510, communication interface 1506, and/or the processing circuitry 1502 may be configured to perform any receiving operations and/or certain obtaining operations described herein as being performed by the network node. Any information, data and/or signals may be received from a UE, another network node and/or any other network equipment. Similarly, the antenna 1510, the communication interface 1506, and/or the processing circuitry 1502 may be configured to perform any transmitting operations described herein as being performed by the network node. Any information, data and/or signals may be transmitted to a UE, another network node and/or any other network equipment.

The power source 1508 provides power to the various components of network node 1500 in a form suitable for the respective components (e.g., at a voltage and current level needed for each respective component). The power source 1508 may further comprise, or be coupled to, power management circuitry to supply the components of the network node 1500 with power for performing the functionality described herein. For example, the network node 1500 may be connectable to an external power source (e.g., the power grid, an electricity outlet) via an input circuitry or interface such as an electrical cable, whereby the external power source supplies power to power circuitry of the power source 1508. As a further example, the power source 1508 may comprise a source of power in the form of a battery or battery pack which is connected to, or integrated in, power circuitry. The battery may provide backup power should the external power source fail.

Embodiments of the network node 1500 may include additional components beyond those shown in FIG. 15 for providing certain aspects of the network node's functionality, including any of the functionality described herein and/or any functionality necessary to support the subject matter described herein. For example, the network node 1500 may include user interface equipment to allow input of information into the network node 1500 and to allow output of information from the network node 1500. This may allow a user to perform diagnostic, maintenance, repair, and other administrative functions for the network node 1500.

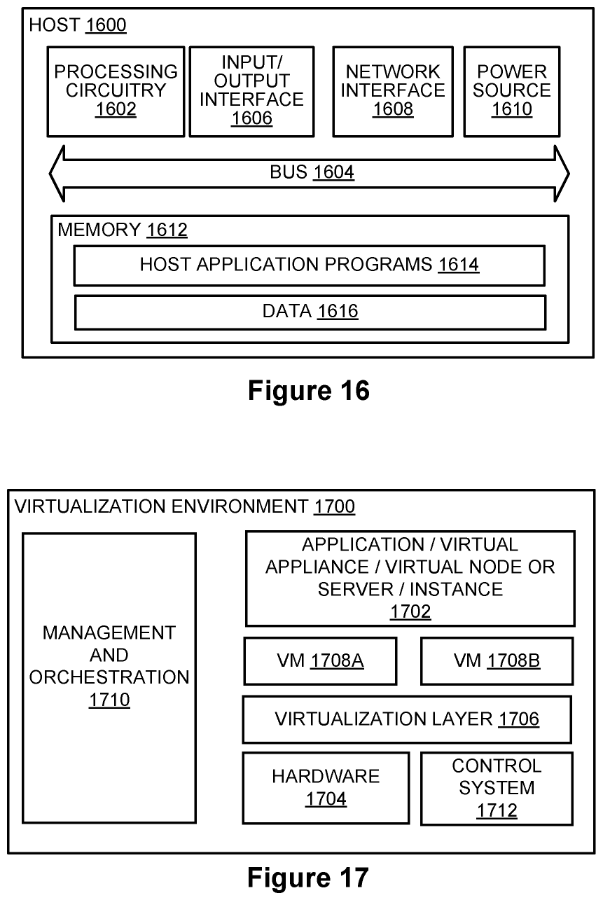

FIG. 16 is a block diagram of a host 1600, which may be an embodiment of the host 1316 of FIG. 13, in accordance with various aspects described herein. As used herein, the host 1600 may be or comprise various combinations hardware and/or software, including a standalone server, a blade server, a cloud-implemented server, a distributed server, a virtual machine, container, or processing resources in a server farm. The host 1600 may provide one or more services to one or more UEs.

The host 1600 includes processing circuitry 1602 that is operatively coupled via a bus 1604 to an input/output interface 1606, a network interface 1608, a power source 1610, and a memory 1612. Other components may be included in other embodiments. Features of these components may be substantially similar to those described with respect to the devices of previous figures, such as FIGS. 14 and 15, such that the descriptions thereof are generally applicable to the corresponding components of host 1600.

The memory 1612 may include one or more computer programs including one or more host application programs 1614 and data 1616, which may include user data, e.g., data generated by a UE for the host 1600 or data generated by the host 1600 for a UE. Embodiments of the host 1600 may utilize only a subset or all of the components shown. The host application programs 1614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1614 may also provide for user authentication and licensing checks and may periodically report health, routes, and content availability to a central node, such as a device in or on the edge of a core network. Accordingly, the host 1600 may select and/or indicate a different host for over-the-top services for a UE. The host application programs 1614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 17 is a block diagram illustrating a virtualization environment 1700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1702 (which may alternatively be called software instances, virtual appliances, network functions, virtual nodes, virtual network functions, etc.) are run in the virtualization environment to implement some of the features, functions, and/or benefits of some of the embodiments disclosed herein.

Hardware 1704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1706 (also referred to as hypervisors or virtual machine monitors (VMMs)), provide VMs 1708a and 1708b (one or more of which may be generally referred to as VMs 1708), and/or perform any of the functions, features and/or benefits described in relation with some embodiments described herein. The virtualization layer 1706 may present a virtual operating platform that appears like networking hardware to the VMs 1708.

The VMs 1708 comprise virtual processing, virtual memory, virtual networking or interface and virtual storage, and may be run by a corresponding virtualization layer 1706. Different embodiments of the instance of a virtual appliance 1702 may be implemented on one or more of VMs 1708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1708 may be a software implementation of a physical machine that runs programs as if they were executing on a physical, non-virtualized machine. Each of the VMs 1708, and that part of hardware 1704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1708 on top of the hardware 1704 and corresponds to the application 1702.

Hardware 1704 may be implemented in a standalone network node with generic or specific components. Hardware 1704 may implement some functions via virtualization. Alternatively, hardware 1704 may be part of a larger cluster of hardware (e.g. such as in a data center or CPE) where many hardware nodes work together and are managed via management and orchestration 1710, which, among others, oversees lifecycle management of applications 1702. In some embodiments, hardware 1704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1712 which may alternatively be used for communication between hardware nodes and radio units.

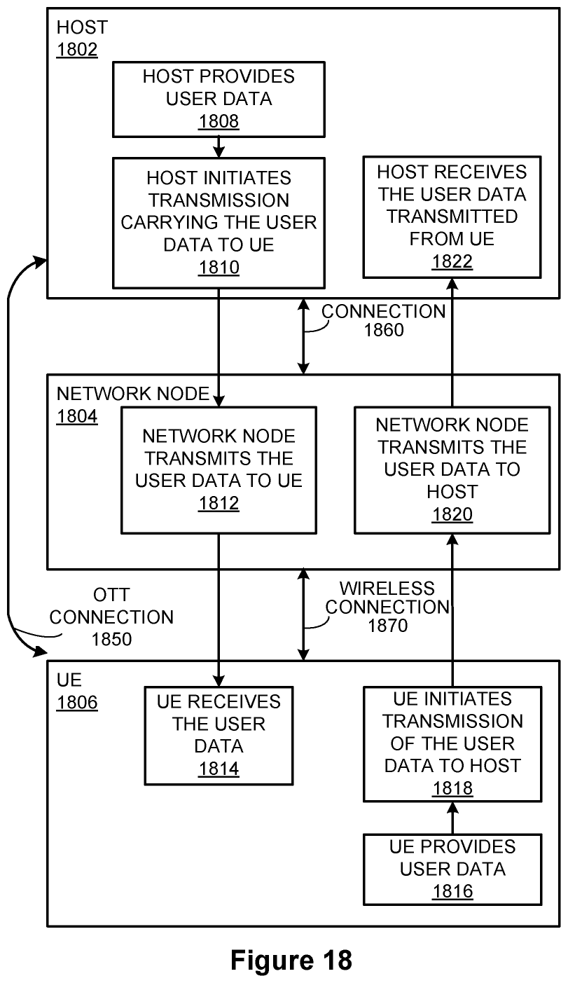

FIG. 18 shows a communication diagram of a host 1802 communicating via a network node 1804 with a UE 1806 over a partially wireless connection in accordance with some embodiments. Example implementations, in accordance with various embodiments, of the UE (such as a UE 1312a of FIG. 13 and/or UE 1400 of FIG. 14), network node (such as network node 1310a of FIG. 13 and/or network node 1500 of FIG. 15), and host (such as host 1316 of FIG. 13 and/or host 1600 of FIG. 16) discussed in the preceding paragraphs will now be described with reference to FIG. 18.

Like host 1600, embodiments of host 1802 include hardware, such as a communication interface, processing circuitry, and memory. The host 1802 also includes software, which is stored in or accessible by the host 1802 and executable by the processing circuitry. The software includes a host application that may be operable to provide a service to a remote user, such as the UE 1806 connecting via an over-the-top (OTT) connection 1850 extending between the UE 1806 and host 1802. In providing the service to the remote user, a host application may provide user data which is transmitted using the OTT connection 1850.

The network node 1804 includes hardware enabling it to communicate with the host 1802 and UE 1806. The connection 1860 may be direct or pass through a core network (like core network 1306 of FIG. 13) and/or one or more other intermediate networks, such as one or more public, private, or hosted networks. For example, an intermediate network may be a backbone network or the Internet.

The UE 1806 includes hardware and software, which is stored in or accessible by UE 1806 and executable by the UE's processing circuitry. The software includes a client application, such as a web browser or operator-specific “app” that may be operable to provide a service to a human or non-human user via UE 1806 with the support of the host 1802. In the host 1802, an executing host application may communicate with the executing client application via the OTT connection 1850 terminating at the UE 1806 and host 1802. In providing the service to the user, the UE's client application may receive request data from the host's host application and provide user data in response to the request data. The OTT connection 1850 may transfer both the request data and the user data. The UE's client application may interact with the user to generate the user data that it provides to the host application through the OTT connection 1850.

The OTT connection 1850 may extend via a connection 1860 between the host 1802 and the network node 1804 and via a wireless connection 1870 between the network node 1804 and the UE 1806 to provide the connection between the host 1802 and the UE 1806. The connection 1860 and wireless connection 1870, over which the OTT connection 1850 may be provided, have been drawn abstractly to illustrate the communication between the host 1802 and the UE 1806 via the network node 1804, without explicit reference to any intermediary devices and the precise routing of messages via these devices.

As an example of transmitting data via the OTT connection 1850, in step 1808, the host 1802 provides user data, which may be performed by executing a host application. In some embodiments, the user data is associated with a particular human user interacting with the UE 1806. In other embodiments, the user data is associated with a UE 1806 that shares data with the host 1802 without explicit human interaction. In step 1810, the host 1802 initiates a transmission carrying the user data towards the UE 1806. The host 1802 may initiate the transmission responsive to a request transmitted by the UE 1806. The request may be caused by human interaction with the UE 1806 or by operation of the client application executing on the UE 1806. The transmission may pass via the network node 1804, in accordance with the teachings of the embodiments described throughout this disclosure. Accordingly, in step 1812, the network node 1804 transmits to the UE 1806 the user data that was carried in the transmission that the host 1802 initiated, in accordance with the teachings of the embodiments described throughout this disclosure. In step 1814, the UE 1806 receives the user data carried in the transmission, which may be performed by a client application executed on the UE 1806 associated with the host application executed by the host 1802.

In some examples, the UE 1806 executes a client application which provides user data to the host 1802. The user data may be provided in reaction or response to the data received from the host 1802. Accordingly, in step 1816, the UE 1806 may provide user data, which may be performed by executing the client application. In providing the user data, the client application may further consider user input received from the user via an input/output interface of the UE 1806. Regardless of the specific manner in which the user data was provided, the UE 1806 initiates, in step 1818, transmission of the user data towards the host 1802 via the network node 1804. In step 1820, in accordance with the teachings of the embodiments described throughout this disclosure, the network node 1804 receives user data from the UE 1806 and initiates transmission of the received user data towards the host 1802. In step 1822, the host 1802 receives the user data carried in the transmission initiated by the UE 1806.

One or more of the various embodiments improve the performance of OTT services provided to the UE 1806 using the OTT connection 1850, in which the wireless connection 1870 forms the last segment. More precisely, the teachings of these embodiments may improve the performance of measurements by a UE and thereby provide benefits such as reduced power consumption and reduction of overhead signalling.

In an example scenario, factory status information may be collected and analyzed by the host 1802. As another example, the host 1802 may process audio and video data which may have been retrieved from a UE for use in creating maps. As another example, the host 1802 may collect and analyze real-time data to assist in controlling vehicle congestion (e.g., controlling traffic lights). As another example, the host 1802 may store surveillance video uploaded by a UE. As another example, the host 1802 may store or control access to media content such as video, audio, VR or AR which it can broadcast, multicast or unicast to UEs. As other examples, the host 1802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1850 between the host 1802 and UE 1806, in response to variations in the measurement results. The measurement procedure and/or the network functionality for reconfiguring the OTT connection may be implemented in software and hardware of the host 1802 and/or UE 1806. In some embodiments, sensors (not shown) may be deployed in or in association with other devices through which the OTT connection 1850 passes; the sensors may participate in the measurement procedure by supplying values of the monitored quantities exemplified above, or supplying values of other physical quantities from which software may compute or estimate the monitored quantities. The reconfiguring of the OTT connection 1850 may include message format, retransmission settings, preferred routing etc.; the reconfiguring need not directly alter the operation of the network node 1804. Such procedures and functionalities may be known and practiced in the art. In certain embodiments, measurements may involve proprietary UE signaling that facilitates measurements of throughput, propagation times, latency and the like, by the host 1802. The measurements may be implemented in that software causes messages to be transmitted, in particular empty or ‘dummy’ messages, using the OTT connection 1850 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

Explanations are provided below for various abbreviations/acronyms used in the present disclosure.

| Abbreviation | Explanation |
|---|---|
| 3GPP | 3rd Generation Partnership Project |
| 5G | 5th Generation |
| ACK | Acknowledgement |
| AR | Augmented reality |
| BLER | Block error rate |
| BS | Base Station |
| BWP | Bandwidth part |
| CHO | Conditional Handover |
| C-MGP | Concurrent MGP |
| CP | Cyclic prefix |
| CSI-RS | Channel state information reference signals |
| CSSF | Carrier-specific scaling factor |
| DCI | Downlink control information |
| DL | Downlink |
| eMBB | Evolved mobile broadband |
| eNB | Evolved NodeB (LTE base station) |
| FDD | Frequency division duplex |
| FNO | Fully non-overlapped |
| FO | Fully overlapped |
| FPO | Full-partially overlapped |
| FR1 | Frequency range 1 |
| FR2 | Frequency range 2 |
| FR3 | Frequency range 3 |
| GEO | Geostationary Orbit |
| gNB | Base station in NR |
| gNB | Next generation Node B (5G base station) |
| HARQ | Hybrid automatic repeate request |
| HO | Handover |
| IMS | IP Multimedia Subsystem |
| LTE | Long Term Evolution |
| MAC | Medium Access Control |
| MG | Measurement Gap |
| MGL | Measurement gap length |
| MGO | Measurement gap offset |
| MGP | Measurement gap pattern |
| MGRP | Measurement gap repetition period |
| MGTA | Measurement gap timing advance |
| MUSIM | Multi-USIM |
| NACK | Negative acknowledgement |
| NR | New Radio |
| NR | New radio (5G) |
| PBCH | Physical broadcast channel |
| PDCCH | Physical downlink control channel |
| PDSCH | Physical downlink shared channel |
| PFO | Partially-fully overlapped |
| PPO | Partially-partially overlapped |
| PRS | Positioning reference signals |
| PUCCH | Physcial uplink control channel |
| PUSCH | Physcial uplink shared channel |
| RAT | Radio Access Technology |
| RIGP | Reference Signal Received Power |
| RRC | Radio Resource Control |
| RRM | Radio Resource Management |
| RS | Reference Signal |
| SCS | Subcarrier spacing |
| SFN | System frame number |
| SMTC | SSB Measurement Timing Configuration |
| SNR | Signal to noise ratio |
| SRS | Sounding reference signal |
| SSB | Synchronization signal and PBCH block |
| TDD | Time division duplex |
| UE | User Equipment |
| UL | Uplink |
| USIM | Universal subscriber identity module |

1. A method performed by a radio node, comprising:
configuring a plurality of measurement gap patterns for performing measurements by a user equipment during measurement gaps;
grouping the plurality of measurement gap patterns into a plurality of measurement gap pattern sets;
determining that an overlap exists between two or more measurement gap occasions belonging to different measurement gap pattern sets; and
adapting at least one of the measurement gap pattern sets in response to determining that the overlap exists.

2. The method of claim 1, wherein determining that the overlap exists comprises determining that the two or more measurement gap occasions within different measurement gap pattern sets meet an inter-gap proximity condition.

3. The method of claim 2, wherein the inter-gap proximity condition defines a relation between a first timing of a first measurement gap pattern set and a second timing of a second measurement gap pattern set.

4. The method of claim 3, wherein the first timing comprises a starting point in time of a measurement gap of the first measurement gap pattern set or an ending point in time of a measurement gap of the first measurement gap pattern set, and wherein the second timing comprises a starting point in time or an ending point in time of a measurement gap of the second measurement gap pattern set.

5. The method of claim 3, wherein the inter-gap proximity condition is met if:
a time difference between the first timing and the second timing is less than a threshold a time difference between the first timing and the second timing is less than a first threshold and greater than a second threshold; or a time difference between the first timing and the second timing is greater than a third threshold.

6. The method of claim 1, wherein adapting the at least one measurement gap pattern set comprises modifying a measurement gap pattern of the at least one measurement gap pattern set.

7. (canceled)

8. The method of claim 1, wherein the plurality of measurement gap patterns are grouped into measurement gap pattern sets provided the measurement gap patterns meet an inter-gap proximity condition.

9. The method of claim 1, wherein the radio node comprises the user equipment and wherein grouping the plurality of measurement gap patterns into measurement gap pattern sets is based on a priority rule among the plurality of measurement gap patterns indicated by a network node.

10-12. (canceled)

13. The method of claim 9, wherein the priority rule comprises at least one of:
that a measurement gap for a positioning measurement has a higher priority than a measurement gap for reference signal, RS, based measurements;
that a measurement gap for measurements in IDLE mode cell reselection has a lower priority than a measurement gap for RS based measurements in CONNECTED mode;
that a gap for handover measurements, paging monitoring, random access channel transmission and/or system information acquisition has a higher priority than a gap for measurements; and
that a gap for PCell L3 measurements has a higher priority than a gap for inter-frequency/inter-radio access technology measurements.

14. The method of claim 1, wherein the radio node comprises the user equipment, the method further comprising:
receiving an indication from a network node of a priority associated with the plurality of measurement gap patterns; and
performing measurements on one or more cells in accordance with the indicated priority.

15. The method of claim 14, wherein the priority indicates which measurement gap occasion should be performed in a measurement gap pattern set in response to an overlap between measurement gap pattern sets.

16-18. (canceled)

19. The method of claim 1, wherein the radio node comprises the user equipment, the method further comprising:
receiving an indication from a network node of a priority associated with the plurality of measurement gap pattern sets; and
performing measurements in accordance with the indicated priority.

20. The method of claim 19, wherein the priority indicates which measurement gap occasion should be performed in a measurement gap pattern set in response to an overlap between measurement gap pattern sets.

21. The method of claim 19, wherein the indication comprises a bitmap that indicates measurement priorities of measurement gap pattern sets.

22. The method of claim 21, wherein the bitmap comprises a bitmap table for different measurement gap occasions for different measurement gap pattern sets.

23. The method of claim 21, wherein the bitmap comprises a direct indication of which measurement gap pattern sets will be prioritized for performing measurements at in each different measurement gap occasion.

24. (canceled)

25. The method of claim 1, wherein the radio node comprises a network node, the method further comprising:
transmitting an indication to the user equipment of a priority associated with the plurality of measurement gap pattern sets; and
configuring the user equipment to perform measurements on one or more cells in accordance with the indicated priority.

26. The method of claim 25, wherein the priority indicates which measurement gap occasion should be performed in a measurement gap pattern set in response to an overlap between measurement gap pattern sets.

27-31. (canceled)

32. A user equipment configured to:
configure a plurality of measurement gap patterns for performing measurements by the user equipment during measurement gaps;
group the plurality of measurement gap patterns into a plurality of measurement gap pattern sets;
determine that an overlap exists between two or more measurement gap occasions belonging to different measurement gap pattern sets; and
adapt at least one of the measurement gap pattern sets in response to determining that the overlap exists.

33. A network node configured to:
configure a plurality of measurement gap patterns for performing measurements by a user equipment during measurement gaps;
group the plurality of measurement gap patterns into a plurality of measurement gap pattern sets;
determine that an overlap exists between two or more measurement gap occasions belonging to different measurement gap pattern sets; and
adapt at least one of the measurement gap pattern sets in response to determining that the overlap exists.
